(19) United States
(12) Patent Application Publication
(10) Pub. No.: US 2009/0254454 A1
(43) Pub. Date: Oct. 8, 2009

(54) Method and system for providing online automobile service comparison, service ranking, expenses comparison, price matching and purchasing the desired services. Based on provisional application 60912189 filed on April 17, 2007 and ID 1688557

(76) Inventor: MOHIT GUPTA, Irvine, CA (US)

Correspondence Address: MOHIT GUPTA, 42 WHISPERING PINE, IRVINE, CA, 92620, US

(21) Appl. No.: 12/099,692

(22) Filed: Apr. 8, 2008

(51) Int. Cl. G06Q 30/00

(52) U.S. Cl. 705/27

(57) ABSTRACT

A method and system for providing online automobile service comparison, service ranking, expense comparisons and online price matching are disclosed. The system provides online automobile service comparison, service ranking, expenses comparison and online price matching through a designated website accessible by a user via a communication network such as the Internet and/or intranet. The method includes the steps of providing optimized information by the system regarding available automobile service stations in a specific area, automobile services offered, customer feedback rankings, cost of desired services, displaying the required information to the user. The method also includes the steps to purchase the desired automobile services. The method also include a system through which service stations can online match their competitor prices based on a pre-defined value/percent for a specific service or plural of services to gain additional business.

### FIELD OF THE INVENTION

The present invention relates to method and system for evaluating, analyzing, assimilating and collating preferred automobile service stations, service garages and automobile repair shops based on but not limited to the total cost of service, user ranking user feedback, earliest available appointment and distance of these vehicle service stations from the user location through a designated website accessible by a user via a communication network such as the internet and/or intranet. The evaluation, analysis, assimilation and collation of the preferred automobile service stations is based on information provided by the user which includes the automobile make, the model, the year, the automobile odometer reading, the nature of servicing to be performed, the condition of the automobile or location of the user. The invention provides the unique flexibility of applying the above described method to a service sector, which has not so far been attempted. In addition, the method of the present invention provides the user the option of collating the preferred automobile service stations list by evaluating, analyzing, more than one of the information provided by the user and more particularly, on a desired preference of the user.

### DISCUSSION OF THE RELATED ART

There are a number of websites that offer online comparison shopping for consumer products, travel related booking and even for shipping. These websites maintain searchable databases containing a variety of different vendor and product information supplied by online vendors either earlier or provided ‘live’. Conventionally, these websites are configured to search for the lowest prices on products requested by a user. Some websites such as http://www.pricegrabber.com provide more sophisticated online comparison shopping wherein the user can enter a shipping location so that shipping and tax costs are included in the compared prices. Other online comparison shopping websites such as http://www.travelocity.com allow the user to purchase the lowest cost flight from a range of different airlines.

PCT Patent Publication No. WO 00/43850 (PCT International Application No. PCT/US00/01401) discloses another online comparison shopping system. In this system, a user is able to purchase multiple items online from different online vendors using a single purchase order. For each item to be purchased, the system compares prices from different vendors and provides a comparison list of vendors that offer the requested item along with the price of the item offered by each vendor. The user views this list and selects one vendor from the list as well as the quantity of the item to be purchased. The user then adds the selected item to his “virtual shopping cart”. This process is repeated for each item that the user wishes to purchase. Once all the items are placed in the virtual shopping cart, the user enters his or her shipping and payment information. This causes the system to generate a single purchase order identifying the user's selected items from multiple vendors. The system disaggregates this: order by sending an appropriate portion of the order to each vendor.

offers a system for evaluating, analyzing, assimilating and collating preferred automobile service stations, service garages and automobile repair shops based on but not limited to the total cost of service, user ranking/feedback, earliest available appointment time and distance of these service stations, from the user location and thus performing an online comparison for automobile servicing and available service stations in a particular geographically located area. This means that the consumer relies only on the information provided to him through printed media, radio and television, multi media advertisements and references from their family and friends. Additionally for routine maintenance requirements for their automobile such as oil changes, brake checks, scheduled maintenance etc they do not get an opportunity to compare the services offered by their local service and repairs stations.

Accordingly, there is a need for a method and system for evaluating, analyzing, assimilating and collating preferred automobile service stations and thus providing online comparison for automobile repairs and maintenances.

### SUMMARY OF THE INVENTION

The present invention provides a method and system for evaluating, analyzing, assimilating and collating preferred automobile service stations and thus providing online comparison for automobile repairs and maintenance requirements.

Particularly, the system of the present invention compiles a list for the user which identifies specific automobile services that the user wishes to be performed, such as but not limited to the oil changes, brake repairs, scheduled maintenances, tire rotations, wheel alignments etc. Then the system allows the user to specify certain optimization criteria (criteria) for obtaining an optimal list based on the user's list. Examples of the optimization criteria can include, but are not limited to, the lowest total cost including any tax, vendor user rating and feedback, earliest available service appointment, location of the desired vendor based on the distance from the user zip code or city, etc.

Based on the user-specified optimization criteria and any optimization criteria pre-set by the system, the system optimizes the user's list to produce an optimal list using existing optimization techniques or programs. That is, the system is configured to generate automatically a single list for purchasing all automobile services on the list, wherein the list satisfies the optimization criteria set by the user and the system. This optimization list will identify a single vendor or multiple vendors for each of the automobile services on the list. The user is able to modify the generated optimal list to reflect any last minute changes by the user. In certain situations, the system may be unable to generate an optimal list because, e.g., no online vendors, automobile service stations, automobile repair garages offer certain automobile services on the list. In these cases, the user is notified of the optimization failure and the system can be configured to re-attempt the optimization process (e.g., after a certain time period) until an optimal list is generated.

If the user approves the optimal list, the list is processed according to known techniques. For example, the list is sent to specific vendors, automobile service stations and automobile repair garages so that appointment and payment of the automobile services identified in the list can be made. Each vendor system is configured, to transmit their confirmation information to the present system. Then the user can view and monitor this confirmation information for all automobile services in the list from one website.

While arriving at the optimal list or while displaying the optimal list, it is possible to rank the individual entries constituting the list. The ranking of each entry in the list can be based on but not limited on one or more of the following parameters:
the lowest total cost for a single or multiple automobile services that would be charged by the service vendor, which may or may not be including sales tax for performing such service(s);
vendor's or automobile service station's or automobile repair garage's preference;
previous user's ranking for the vendor or automobile service station or automobile service garage;
previous user's feedback for the vendor or automobile service station or automobile service garage;
the vendor's or automobile service station's or automobile service garage's closeness to the user;
availability of a user-preferred payment method at the vendor or automobile service station or automobile service garage;
the fastest appointment time available;
the least expected time period for performing the service;
nature of service availability;
the price range of various services; and
the total cost.

If the user chooses more than one parameter for arriving at the ranking, then the ranking may be arrived at by taking a weighted average of the various parameters thus chosen by the user. For example, the system will calculate the weighted average of various parameters to reflect the best possible option for the user as per the criteria defined by the user.

To further explain this, a user can input desired criteria such as total cost and/or user rating/ranking and/or total distance from the user home and/or the earliest appointment time to calculate the weighted average of all these criteria and recommend the automobile service station which will have the highest weighted average number.

The system will perform this function by assigning weighting to each attribute. It will then calculate an average in which each attribute to be averaged is assigned a weight. These weightings determine the relative importance of each quantity on the average. Weightings are the equivalent of having that many like items with the same value involved in the average.

The weighted mean, or weighted average, of a non-empty list of data
[x₁, x₂, x₃, x₄, . . . , xₙ]

with corresponding non-negative weights
[w₁, w₂, . . . , wₙ],

at least one of which is positive, is the quantity calculated by

$$\overline{x} = \frac{{\sum }_{i = 1}^{n} {w}_{i} {x}_{i}}{{\sum }_{i = 1}^{n} {w}_{i}} ,$$

which means:

$$\overline{x} = \frac{{w}_{1} {x}_{1} + {w}_{2} {x}_{2} + … + {w}_{n} {x}_{n}}{{w}_{1} + {w}_{2} + … + {w}_{n}} .$$

So data elements with a high weight contribute more to the weighted mean than do elements with a low weight.

For demonstration purposes we will assign following weightings to different attributes:

| | |
|---|---|
| Total cost | 40 (rating range 1-5, best being 5) |
| User rating | 35 (rating range 1-5, best being 5) |
| Distance from the user home | 20 (rating range 1-5, best being 5) |
| Earliest available appointment | 5 (rating range 1-5, earliest being 5) |

Now if there are two service station with following criteria

| | Service station-1 | Service station-2 |
|---|---|---|
| Total cost | $100 | $125 |
| User rating | 4 | 5 |
| Distance from the user home | 10 miles | 15 miles |
| Earliest available appointment | 2 days | 2 days |

The weighted average for the above will be

| | Service station-1 | Service station-2 |
|---|---|---|
| Total cost | 5 × 40 = 200 | 4 × 40 = 160 |
| User rating | 4 × 35 = 140 | 5 × 35 = 175 |
| Distance from the | 5 × 20 = 100 | 4 × 20 = 80 |
| user home | | |
| Earliest available | 2 × 5 = 10 | 2 × 5 = 10 |
| appointment | | |
| Total | 350 | 425 |
| Weighted average | 350/(40 + 35 + 20 + 5) | 425/(40 + 35 + 20 + 5) |
| Weighted average | 3.5 | 4.25 |

Based on the above example the service station 2 is a better choice even though it has higher cost and is farther in distance from the user home. The reason for this is due to higher weighting of user ranking attribute.

The invention being thus described, it will be obvious that the same may be varied in many ways. Such variations are not to be regarded as a departure from the spirit and scope of the invention, and all such modifications as would be obvious to one skilled in the art are intended to be included in the present invention.

### BRIEF DESCRIPTION OF THE DRAWINGS

FIG. 1 is a flowchart illustrating the processing steps of a method for providing online comparison according to one embodiment of the present invention.

FIG. 2 is a flowchart illustrating the processing steps of a method for providing online comparison according to another embodiment of the present invention.

FIG. 3 is a block diagram of a system for providing online comparison according to one embodiment of the present invention.

FIG. 4 is a block diagram of a system providing the user with various features from this invention.

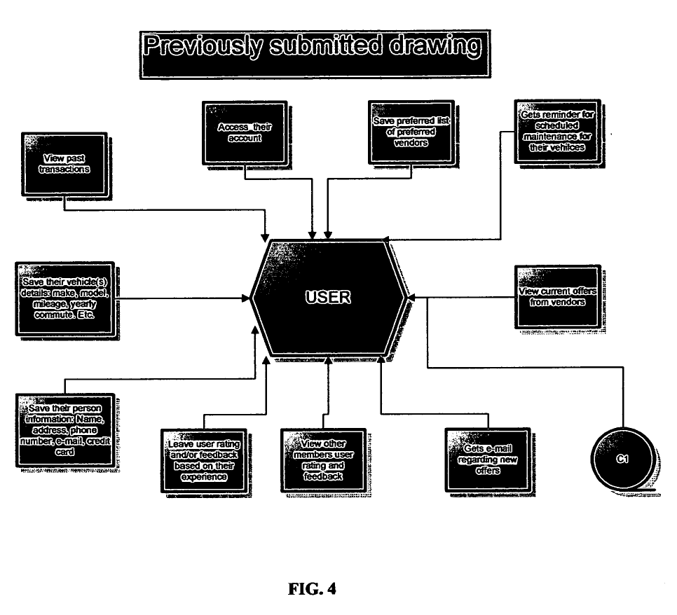

FIG. 5 is a block diagram of a system illustrating the steps for online price matching of services/repairs by a vendor so that it can compete with other vendor with respect to price.

### DETAILED DESCRIPTION OF THE PREFERRED EMBODIMENTS

In the drawings, the same reference numerals are used to indicate the same elements.

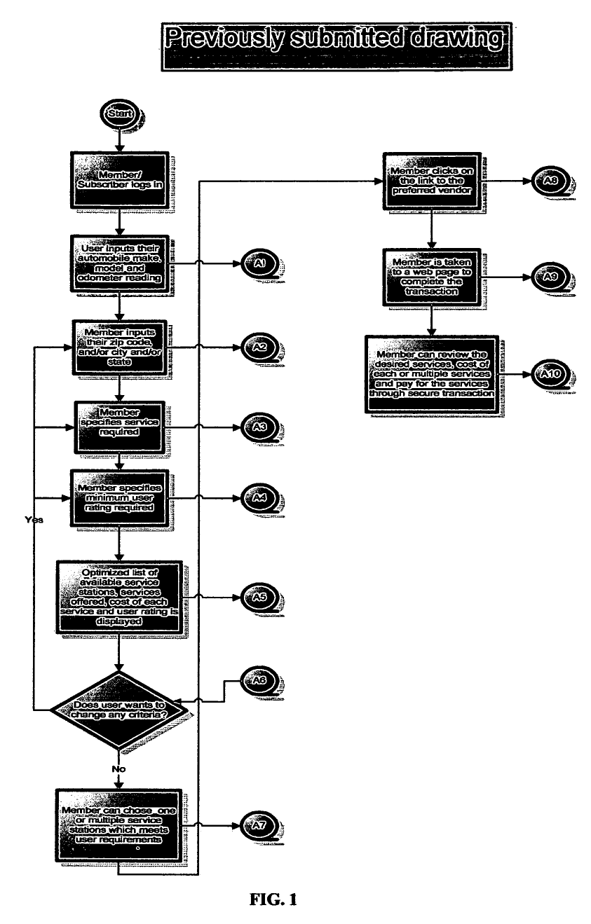

FIG. 1 is a flowchart illustrating the processing steps of a method of providing online comparison according to one embodiment of the present invention. These processing steps can be implemented by a computer program executable by a computer system Preferably, these processing steps are implemented by an online comparison website system that provides and maintains an online comparison website accessible by users through the Internet.

As shown in FIG. 1, the user logs into the website to access their account.

In step A1 they input the details of their automobile such as make, model and odometer reading.

In step A2 the user inputs the zip code and/or their city name where they would like to get their automobile serviced or repaired. This can be accomplished through a drop down menu or by other means available on the website.

In step A3 the user specifies the service required. This will be drop down menu which will list multiple service options such as oil changes, tire rotation, wheel alignment, 30K, 60K, 90K scheduled maintenances, air-conditioning repairs etc. The user will be able to select the services offered based on the input regarding their automobile make and model and odometer readings.

In step A4, the user will input minimum rating of the desired service stations. This means that if the user wants to get a list of only those vendors, automobile service stations which have a ranking of higher than 3 (out of possible 5) then they can specify this by a drop down menu for minimum ranking. This step will eliminate service stations and garages with lower ranking than specified by the user.

In step A5, the user will be able to view an optimized list based on the input criteria. The system is configured to identify the user's preferred optimization/criteria to be used in determining an optimal list for the list. This can be accomplished by providing graphical user interfaces or menus that list a number of different categories of optimization criteria for the user's selection. The optimization criteria selectable by the user can be one or more of the following examples of criteria: zip code, services required and minimum ranking required. If multiple optimization criteria are selected by the user, the user may be able to set a priority list in which these criteria are to be applied, or the system can set this priority list according to predetermine guidelines. In addition, to the optimization criteria selectable by the user, there may exist a set of “fixed” optimization criteria that are pre-set by the system and always used by the system during the list optimization process. The fixed optimization criteria may not be “turned off” by the user. Such fixed optimization criteria may include, but are not limited to, special offers by vendors, automobile service stations and automobile repair garages.

In Step A5, once the user selects or identifies the user's preferred optimization criteria, the list is optimized based on the user's optimization criteria and any fixed optimization criteria to produce an optimal list. This is accomplished using existing optimization techniques or computer programs.

In some cases, the system is not able to generate an optimal list because, e.g., the user has requested a service that is currently not offered by any online vendor or the user has specified a total price limit that currently cannot be met. If the optimization process (Step A5) does not produce an optimal list, i.e., if the system determines at Step A5 that an optimal list does not exist, then this optimization failure is reported to the user in Step A5, e.g., by displaying a message on the user's screen.

In step A6, the user can make changes to their previous input criteria due to several reasons such as desire for additional listing of available garages, list of available garages which are offering better price but may have lower rankings particular, change in the services required etc. If the user make any changes the system take them back to either step A1, A2, A3 or A4 depending upon which change was made.

In step A7, the user can chose the preferred vendor and service from the optimized list.

Once the user makes their selection in terms of service station and or/service required, each vendor sends their confirmation information to the present system in Step A8, e.g., via the Internet according to known web page/message communication techniques. The system is configured to display to the user (e.g., on the user's display device) the confirmation information for all f the automobile services identified in the optimal list.

In step A9, the user is taken to a secured web page which will display the summary of the selection in terms of service station name, address, service requested, cost of each service, the ranking of the service station and option to make reservation for the service at the desired service location.

In step A10, the user will be able to pay all required charges for the requested service through a secure web transaction.

According to the present invention, all optimal lists (both online and off-line) are verified using known validation techniques, just before the user can check out the list. This is to ensure that the list that is checked out by the user is valid when the actual check-out occurs. Such a validation process is well known in the art. For example, on-line airline reservation systems such as http://www.travelocity.com verify that the flight and the pricing are still valid just before a check-out can be made because prices and even the availability of specific flights can change within minutes due to the complicated pricing structure of airline flights and the limited number of seats per flight.

In the present embodiment, when the user makes modifications to the optimal list as in Step A6, the system automatically re-optimizes the list by returning to Step A2. However, in another embodiment, the user is able to choose either the fill re-optimization of the optical list or a simple cost recalculation of the list based on the user's modifications. This selection can be made in advance or when the user modifies the optimal list. If the user selects the cost recalculation, then the system merely recalculates the total list cost based on the user's modification and does not necessarily perform the full optimization process.

The processing steps and the components of the present invention can be implemented by computer programs in conjunction with hardware components. Software programing code which embodies the present invention may be stored on any of a variety of known media such as a diskette, hard drive, CD-ROM, or read-only memory, and may be distributed on such media. The techniques and methods for embodying software programming code on physical media and/or distributing software code are known in the art.

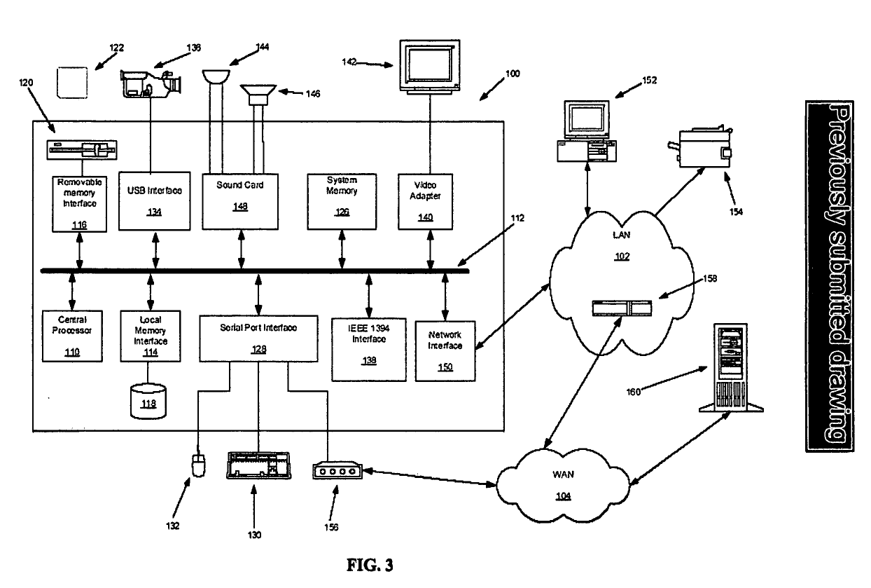

Various embodiments of the present invention may be implemented with computer devices and systems that exchange and process data. Elements of an exemplary computer system are illustrated in FIG. 3, in which the computer 100 is connected to a local area network (LAN) 102 and a wide area network (WAN) 104. Computer 100 includes a central processor 110 that controls the overall operation of the computer and a system bus 112 that connects central processor 110 to the components described below. System bus 112 may be implemented with any one of a variety of conventional bus architectures.

Computer 100 can include a variety of interface units and drives for reading and writing data or files. In particular, computer 100 includes a local memory interface 114 and a removable memory interface 116 respectively coupling a hard disk drive 118 and a removable memory drive 120 to system bus 112. Examples of removable memory drives include magnetic disk drives and optical disk drives. Hard disks generally include one or more read/write heads that convert bits to magnetic pulses when writing to a computer-readable medium and magnetic pulses to bits when reading data from the computer readable medium. A single hard disk drive 118 and a single removable memory drive 120 are shown for illustration purposes only and with the understanding that computer 100 may include several of such drives. Furthermore, computer 100 may include drives for interfacing with other types of computer readable media such as magneto-optical drives.

Unlike hard disks, system memories, such as system memory 126, generally read and write data electronically and do not include read/write heads. System memory 126 may be implemented with a conventional system memory having a read only memory section that stores a basic input/output system (BIOS) and a random access memory (RAM) that stores other data and files.

A user can interact with computer 100 with a variety of input devices. FIG. 3 shows a serial port interface 128 coupling a keyboard 130 and a pointing device 132 to system bus 112. Pointing device 132 may be implemented with a hard-wired or wireless mouse, track ball, pen device, or similar device.

Computer 100 may include additional interfaces for connecting peripheral devices to system bus 112. FIG. 3 shows a universal serial bus (USB) interface 134 coupling a video or digital camera 136 to system bus 112. An IEEE 1394 interface 138 may be used to couple additional devices to computer 100. Furthermore, interface 138 may be configured to operate with particular manufacture interfaces such as FireWire developed by Apple Computer and i.Link developed by Sony. Peripheral devices may include touch sensitive screens, game pads scanners, printers, and other input and output devices and may be coupled to system bus 112 through parallel ports, game ports, PCI boards or any other interface used to couple peripheral devices to a computer.

Computer 100 also includes a video adapter 140 coupling a display device 142 to system bus 112. Display device 142 may include a cathode ray tube (CRI), liquid crystal display (LCD), field emission display (FED), plasma display or any other device that produces an image that is viewable by the user. Sound can be recorded and reproduced with a microphone 144 and a speaker 146. A sound card 148 may be used to couple microphone 144 and speaker 146 to system bus 112.

One skilled in the art will appreciate that the device connections shown in FIG. 3 are for illustration purposes only and that several of the peripheral devices could be coupled to system bus 112 via alternative interfaces. For example, video camera 136 could be connected to IEEE 1394 interface 138 and pointing device 132 could be connected to USB interface 134.

Computer 100 includes a network interface 150 that couples system bus 112 to LAN 102. LAN 102 may have one or more of the well-known LAN topologies and may use a variety of different protocols, such as Ethernet. Computer 100 may communicate with other computers and devices connected to LAN 102; such as computer 152 and printer 154. Computers and other devices may be connected to LAN 102 via twisted pair wires, coaxial cable, fiber optics or other media. Alternatively, radio waves may be used to connect one or more computers or devices to LAN 102.

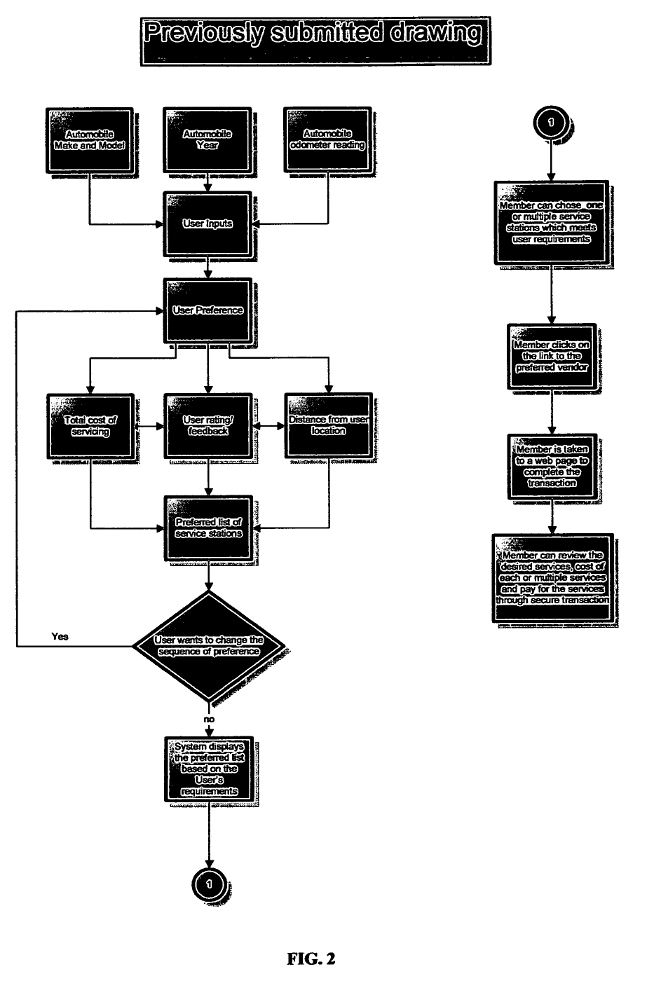

A wide area network 104, such as the Internet, can also be accessed by computer 100. FIG. 3 shows a modem unit 156 connected to serial port interface 128 and to WAN 104. Modem unit 156 may be located within or external to computer 100 and may be any type of conventional modem, such as a cable modem or a satellite modem. LAN 102 may also be used to connect to WAN 104. FIG. 2 shows a router 158 that may connect LAN 102 to WAN 104 in a conventional manner. A server 160 is shown connected to WAN 104. Of course, numerous additional servers, computers, handheld devices, personal digital assistants, telephones and other devices may also be connected to WAN 104.

The operation of computer 100 and server 160 can be controlled by computer executable instructions stored on a computer-readable medium. For example, computer 100 may include computer-executable instructions for transmitting information to server 160, receiving information from server 160 and displaying the received information on display device 142. Furthermore, server 160 may include computer-executable instructions for transmitting hypertext markup language (HTML), extensible markup language (XML) or voice extensible markup language (VXML) computer code to computer 100.

As noted above, the term “network” as used herein and depicted in the drawings should be broadly interpreted to include not only systems in which remote storage devices are coupled together via one or more communication paths, but also stand-alone devices that may be coupled, from time to time, to such systems that have storage capability. Consequently, the term “network” includes not only a “physical network” 102, 104, but also a “content network,” which is comprised of the data—attributable to a single entity—which resides across all physical networks.

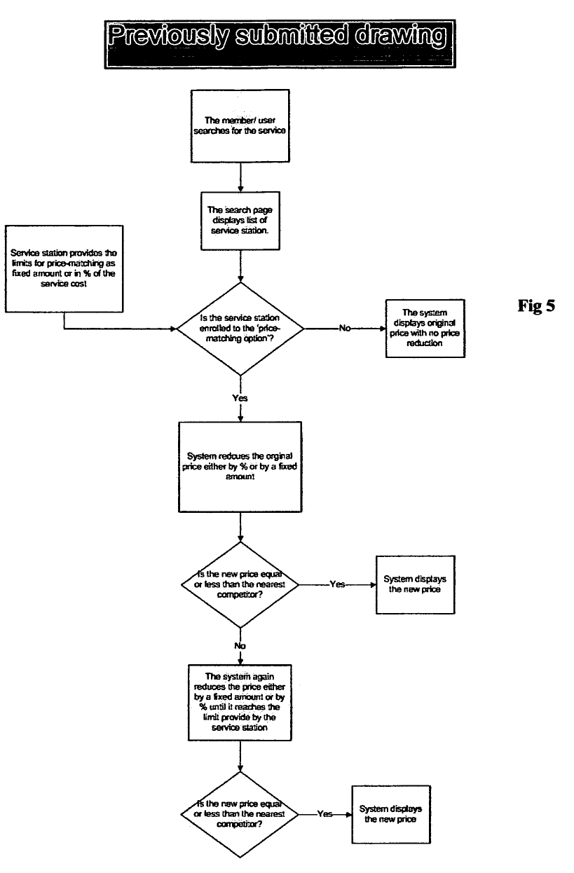

FIG. 5 is a block diagram of a system illustrating the steps for online price matching of services/repairs by a vendor so that it can compete with other vendor with respect to price. As per the diagram, the system will check if the current price offered by the service station is lower than the other competitors price. If it is not the lowest, then the system using logical steps, reduce the price to a predetermined levels until the new price is lower or equal to the competitor price.

1. A method for evaluating, analyzing, assimilating and collating preferred automobile service stations, said method comprising the steps of:
(a) receiving from a user a “user's list” identifying at least one service desired to be performed by the user;
(b) receiving from the user one or more optimization criteria to be applied;
(c) generating a “vendor list” identifying the vendors who could provide the at least one service contained in the user's list;
(d) for each of the vendor thus contained in the vendor list, applying the one or more optimization criteria received from the vendor list so as to obtain a score for each of the vendor;
(e) generating an “optimized vendor list”, the said “optimized vendor list” listing the vendors based on chronological order of their score; and
(f) displaying the optimized vendor list to the user, the said optimized vendor list containing at least the cost quoted by the vendor for performing the said at least one service contained in the user's list.

2. The method of claim 1, wherein the at least one service includes automobile repair and automobile maintenance service.

3. The method of claim 1, wherein the at least one optimization criteria is selected from the group comprising the lowest total cost which optionally includes any tax payable, vendor user rating and feedback, earliest available service appointment and location of the desired vendor based on the distance from the user zip code or city.

4. The method of claim 1, wherein in step (b) plurality of optimization criteria are received from the user.

5. The method of claim 1, further comprising: for each of the vendor thus contained in the vendor list, applying the plurality of the optimization criteria received from the vendor list so as to obtain plurality of scores, the plurality of scores including the score of the vendor for each of the individual optimization criteria and an average score for the vendor.

6. The method of claim 1, further comprising of
(a) generating the “optimized vendor list”, the said “optimized vendor list” listing the vendors based on chronological order of their average score.
(b) displaying the optimized vendor list to the user, the said optimized vendor list comprising at least the cost quoted by each of the vendor for performing the said at least one service contained in the user's list and the average score of each of the vendor.
(c) receiving from the user weights for each of the plurality of optimization criteria a corresponding weight.
(d) applying the plurality of the optimization criteria received from the vendor list and the corresponding weight so as to obtain plurality of scores including the weighted score of the vendor for each of the individual optimization criteria and a weighted average score.
(e) generating the “optimized vendor list”, the said “optimized vendor list” listing the vendors based on chronological order of their weighted average score.
(f) displaying the optimize vendor list to the user, the said optimized vendor list comprising at least the cost quoted by each of the vendor for performing the said at feast one service contained in the user's list and the weighted average score of each of the vendor.
(g) generating the “optimized vendor list”, the said “optimized vendor list” listing the vendors based on chronological order of their weighted score for a particular optimization criteria chosen by the user.
(h) displaying the optimized vendor list to the user, the said optimized vendor list comprising at least the cost quoted by each of the vendor for performing the said at least one service contained in the user's list and the weighted score of each of the vendor for the particular optimization criteria chosen by the user.

7. The method of claim 1, wherein if the “vendor list” or the “optimized vendor list” thus generated does not contain even one vendor details, an “optimization failure message” is displayed to the user.

8. The method of claim 7, wherein if the optimization failure message is displayed to the user, the method optionally further comprises repeating step (a) to (f) after a predetermined amount of time.

9. The method of claim 7, wherein if the optimization failure message is displayed to the user, the method optionally further comprises providing an opportunity to modify the one of the optimization criteria thus chosen.

10. The method of claim 1, further comprising: receiving one or more further optimization condition from the user after the optimized vendor list has been displayed to the user and regenerating a further optimized vendor list in response thereto.

11. A method for allowing a vendor of a service to control pricing of services provided by him to a online comparative shopping system, said method comprising the steps of:
(a) enabling the service provider to upload at feast two levels of pricing for the same service to be used by the system; and
(b) enabling the service provider to upload at least one condition under which at least one of the said pricing levels would be used by the system for being displayed to a prospective customer.

12. The method of claim 7, wherein the at least two levels of pricing comprise a first level of pricing which is greater than a second level of pricing.

13. The method of claim 7, wherein the at least one condition specifies the criteria to be satisfied under which the system can utilize the second level of pricing.

14. The method of claim 7, wherein at least one of the said at least two pricing levels is uploaded by the service provider upon demand by the system.

15. A method for evaluating, analyzing, assimilating and collating preferred automobile service stations, said method comprising the steps of:
(a) receiving from a user a “user's list” identifying at least one service desired to be performed by the user;
(b) receiving from the user one or more optimization criteria to be applied;
(c) generating a “vendor list” identifying the vendors who could provide the at least one service contained in the user's list;
(d) for each of the vendor thus contained in the vendor list, applying the one or more optimization criteria received from the vendor list so as to obtain a score for each of the vendor;
(e) generating a “first optimized vendor list”, the said “first optimized vendor list” listing the vendors based on chronological order of their score; and
(f) providing an opportunity to at least one vendor who is capable of providing the service and who has not been listed in the “first optimized vendor list” to change one or more of the price quoted or the terms and conditions of servicing;
(g) recalculating the score of the said at least one vendor who has changed one or more of the price quoted or the terms and conditions of servicing and based on the same, generating a “second optimized vendor list”; and
(h) displaying the second optimized vendor list to the user.

16. A online price matching computer program for providing a feature of online price matching of one service or plural services based on the predefined criteria provided by the vendor to reduce the price either by a fixed value or by a specified percent if the vendor does not have the lowest price as compared to other vendors and the steps to evaluate the current price of the vendor and comparing it with other vendor prices, verifying the criteria provided by the vendor for reducing the price either by a fixed number of by a fixed percentage, reducing the price of the vendor if the predefined criteria allows to reduce the price, comparing the new reduced price after the price has been reduced based on the predefined criteria, displaying the new reduced price, if the new price is equal or lower than the closest competitor price and reducing the price further if the new price is not lower or equal to the competitor price.
